(19) United States
(12) Patent Application Publication
(10) Pub. No.: US 2003/0207765 A1
(43) Pub. Date: Nov. 6, 2003

(54) Method for fabricating a metal-clad superconductive body, and article comprising body

(76) Inventors: Christopher A. Bower, New Providence, NJ (US); Sungho Jin, Millington, NJ (US); Hareesh Mavoori, Piscataway, NJ (US); Robert Bruce Van Dover, Maplewood, NJ (US)

Correspondence Address: Docket Administrator, Agere Systems Inc., P.O. Box 614, Berkeley Heights, NJ, 07922-0614, US

(21) Appl. No.: 09/921,223

(22) Filed: Aug. 2, 2001

Related U.S. Application Data
(60) Provisional application No. 60/275,257, filed on Mar. 12, 2001.

(51) Int. Cl. H01B 1/00

(52) U.S. Cl. 505/100

(57) ABSTRACT

It was discovered that metals useful for cuprate superconductor wires and ribbons, such as Ag, Cu, and Au, are not necessarily desirable for magnesium boride superconductor bodies, since such elements tend to react with Mg and thereby deteriorate the properties of the superconducting MgB₂. The invention relates to techniques and materials that provide useful MgB₂ superconducting bodies. The invention relates to a method for forming a MgB₂ superconducting body, involving providing an intermediate body of a metal cladding; superconducting material or precursor material for superconducting material; and, optionally, a diffusion barrier (depending on the type of metal cladding); performing a cross-section reducing operation on the intermediate body, to provide an elongate body; and performing a heat treatment of the elongate body, to obtain desired properties from the superconducting material (and to also form the superconducting MgB₂ material when precursor material is used).

### CROSS-REFERENCE TO RELATED APPLICATION

This application claims priority of Provisional Application Serial No. 60/275257 which was filed Mar. 12, 2001.

### FIELD OF THE INVENTION

This invention pertains to metal-clad superconductor structures, in particular, superconductive wire-like and ribbon-like bodies.

### BACKGROUND OF THE INVENTION

Since the discovery of superconductivity in 1911, many types of superconducting materials have been found with the superconducting transition temperature (T_{c}) of newly-discovered materials steadily going up, e.g., from the traditional alloy type low-T_{c} superconductors such as NbTi, Nb₃Sn, to the cuprate high-T_{c} superconductors such as Y—Ba—Cu—O, and Bi—Sr—Ca—Cu—O. Cuprate high-T_{c} superconductors exhibit high transition temperatures beyond ˜90 K, but the Y—Ba—Cu—O superconductors tend to show a grain boundary weak link problem in polycrystalline structure, resulting in substantially diminished critical current density (J_{c}) unless the material is thoroughly grain aligned or textured. The Bi—Sr—Ca—Cu—O type superconductors have less of a grain boundary weak link problem, but begin to exhibit a flux creep problem at an operating temperatures of ˜20K or higher.

Recently, superconductivity was discovered in another new class of materials. See, for instance, J. Nagamatsu et al., Nature, Vol. 410, p. 63, March, 2001, which reviews the properties of superconductivity in a MgB₂ compound with the T_{c} as high as 39K, and D. C. Larbalestier et al., Nature, Vol. 410, p. 186, March, 2001, which describes the strongly linked current flow in a polycrystalline MgB₂ superconductor.

For most practical applications of superconductors, the material needs to be in a wire or ribbon form capable, for example, of being wound into a solenoid superconducting magnet, or of being used as electricity-carrying transmission lines or lead cables for superconducting power devices. Such filamentary wires and ribbon-like bodies can be incorporated into a variety of apparatus such as power transmission lines, rotating machinery, maglev vehicles, superconducting solenoid magnets for e.g., fusion generators, MHD (magneto-hydro-dynamic) generators, particle accelerators, levitated vehicles, magnetic separation, and energy storage devices. Commercially useful bulk superconductor wires or ribbons, in general, require stabilization using normal metal cladding surrounding the superconductor core. The normal metal in such a clad-core composite structure serves several essential functions of providing a) parallel by-pass electrical path to carry current in case there is a local loss of superconductivity in the core, b) mechanical protection of the generally brittle superconductor cores against Lorentz force during high-field operation of superconducting solenoid magnets, and c) thermal conduction path to minimize local heating and prevent catastrophic loss of superconductivity by local temperature rise.

Like the cuprate oxide type superconductors, the new MgB₂ type boride superconductors are basically ceramic materials and hence are mechanically hard and brittle. It is therefore difficult to draw the MgB₂ type superconductors into desirable fine-wire configuration. A solution for cuprate superconductors was disclosed in U.S. Pat. No. 4,952,554 to Jin et al., the disclosure of which is hereby incorporated by reference. According to this solution, the brittle oxide powder was placed in a ductile, and non-reactive metal tube or jacket, which was then wire drawn and sintered to produce superconducting wires. Metal silver was found to be one of the few, chemically nonreactive metals with respect to the cuprate superconductors which also allowed diffusion of oxygen to the oxide superconductor to ensure the superconductivity.

Techniques and materials for forming useful wire and/or ribbon forms of MgB₂ superconductors are also desired.

### SUMMARY OF THE INVENTION

It was discovered that metals useful for cuprate superconductors, such as Ag, Cu, and Au, are not necessarily desirable for magnesium boride superconductors, since such elements tend to react with Mg and thereby deteriorate the properties of the superconducting MgB₂. The invention relates to techniques and materials that provide useful MgB₂ superconducting bodies.

In general, the invention involves a method for forming a MgB₂ superconducting body. The method involves steps of:

providing an intermediate body of a metal cladding; superconducting material or precursor material for superconducting material; and, optionally, a diffusion barrier (depending on the type of metal cladding);

performing a cross-section reducing operation on the intermediate body, to provide an elongate body; and

performing a heat treatment of the elongate body, to obtain desired properties from the superconducting material (and to also form the superconducting MgB₂ material when precursor material is used).

The metal cladding is desired to substantially eliminate interaction of the magnesium boride superconductive material or superconductor precursor material with the environment. Specifically, due to magnesium's high volatility, exposure to the environment will lead to loss of Mg and deviation from the desired superconductive compound stoichiometry, and/or will lead to oxidation of the MgB₂ due to Mg's high reactivity. However, obtaining a cladding that performs these functions is a complex task. In particular, MgB₂ is strongly reactive, and tends to combine with many metals to form low melting point intermetallics or solid solutions. Such low melting point materials would deteriorate such metal claddings, allowing out-diffusion of Mg and/or oxidation to occur. Thus, it was discovered that either cladding materials substantially inert to magnesium boride had to be used, or diffusion barriers needed to be added with cladding materials that are not sufficiently inert.

(Superconducting bodies according to the invention are referred to herein as wires and/or ribbons. This usage is not intended to imply any limitation in configuration, e.g., such bodies may have noncircular cross sections and may have a multiplicity of coaxial superconductive bodies).

### BRIEF DESCRIPTION OF THE DRAWINGS

FIGS. 1A and 1B schematically illustrate two embodiments of superconductors bodies according to the invention.

FIG. 2 schematically illustrates processing steps according to an embodiment of the invention.

FIGS. 3A and 3B schematically illustrate two embodiments of superconducting bodies according to the invention.

FIG. 4 schematically illustrates an embodiment of a superconducting body according to the invention.

FIG. 5 shows magnetic susceptibility vs. temperature for a MgB₂ body according to the invention.

FIG. 6 shows J_{c} (magnetization) vs. temperature for a MgB₂ body according to the invention.

FIG. 7 shows M vs. H loops for a MgB₂ body according to the invention.

FIG. 8 shows resistivity vs. temperature for a MgB₂ body according to the invention.

FIGS. 9A to 9E show various aspects of a MgB₂ body according to the invention.

FIG. 10 shows J_{c} vs. H plots for MgB₂ bodies according to the invention.

### DETAILED DESCRIPTION OF THE INVENTION

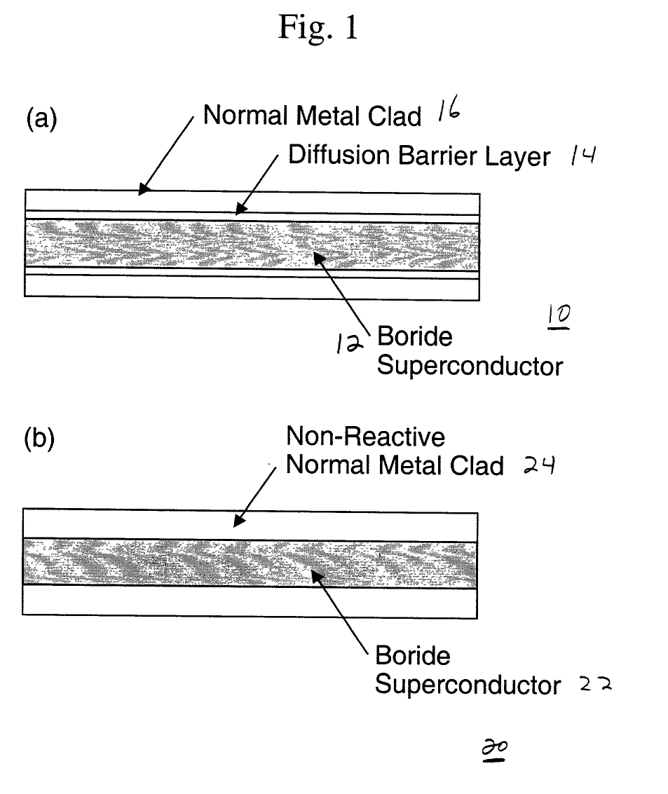

In general, as reflected in FIG. 1A, the intermediate body 10 according to the invention typically contains a quantity of magnesium boride powder 12 (or precursor powder, e.g., the elemental powder constituting the superconductor, or other types of precursors, such as a decomposeable material like MgH₂), optionally surrounded by a diffusion barrier 14, which in turn is surrounded by a metal cladding or jacket 16.

A useful material for the metal jacket is a copper tube (or alternatively alloys comprising Cu such as brass or bronze, Ni and Ni-rich alloys, Fe and Fe-rich alloys such as stainless steel). (“Rich” as used herein, indicates greater than 50 atomic percent of an element.) The metal cladding generally has a melting temperature higher than that of the MgB₂ superconductor. The cladding should have sufficient conductivity for the intended application of the superconducting body.

The diffusion barrier, when present, generally is a thin-walled metal selected from e.g., Fe, Ni, Ti, Mo, Nb, Ta, W, V, or Hf. Fe, Ni and Ti, as well as alloys rich in these metals, are particularly useful, in that they are more ductile than refractory metals. These mechanical considerations are important, because when the preform composite containing the superconductive boride powder is subjected to a elongating and cross-section reducing shaping operation, the diffusion barrier also has to undergo plastic deformation. Any occurrence of fracture or microcracking of the diffusion barrier, which is more likely in a refractory metal diffusion barrier, would allow the Mg vapor to easily contact the clad metal and cause undesirable reactions. Stresses from other shaping operations such, for instance, helical winding of the finished superconductive wire or ribbon on a mandrel into the shape of a magnet coil, may also cause cracking. In addition to Mg diffusion, the presence of such microcracks may serve as nuclei for superconductor wire fracture in the presence of unavoidable or inadvertent stresses.

The use of proper metal cladding has been found to be critical because of the strong chemical reactivity of MgB₂. Magnesium in MgB₂ tends to react and combine with many metals, e.g., Cu and Ag, to form solid solutions or intermetallics with lowered melting points (e.g., as low as ˜480° C. m.p. in the case of eutectic formation), which renders the metal cladding useless during sintering of MgB₂ at around 900-1000° C. Diffusion barrier metals have to be used for such reactive clad metals, which complicates the wire fabrication. There are a relatively small number of essentially inert metals which exhibit no or little mutual solubility with Mg and do not form intermetallic compounds with Mg. As reflected in FIG. 1B, if the metal jacket 24 material is chosen such that the metal has relatively low reactivity with the Mg in the MgB₂ 22, then a diffusion barrier can be omitted from the superconductive body 20. Fe, Ni, Ti, Mo, Nb, Ta, W, V, Hf are examples of such relatively inert metals. (Nickel forms intermetallic compounds with Mg but the mutual solid solubility is small and the kinetics of reaction are believed to be slow enough to be acceptable.) Particularly useful, relatively non-reactive clad metals are Fe, Ni and Ti, or alloys rich with these elements.

The heat treatment to consolidate the boride superconductor powder (typically ˜700-1000° C.) may cause softening of the metal component(s) of the elongate body. To produce bodies having useful formability prior to cross-section reducing, and useful mechanical strength after heat treating, it is possible to use a precipitation-hardenable metal as cladding material. Such alloys (e.g., maraging steels of iron-rich Fe—Ni—Mo base alloys, or Cu—Ni—Sn spinodal alloy) are hardened by a relatively low temperature treatment after wire drawing and shaping, or even on cooling from the sintering or melting process. Such treatment typically does not affect the superconductive properties of the magnesium boride. If applied to a properly shaped superconductive wire or tape (e.g., a helical coil) such metals can result in an article that is stronger and able to more readily handled and further processed, compared to other metal jacket materials.

Cross-section reduction to obtain an elongated body is performed by any suitable technique, e.g., drawing or rolling, that provides the desired wire or ribbon size/configuration.

The heat treatment of the elongate body is carried out such that substantial sintering/consolidation of the magnesium boride powder occurs, for example, at temperatures of 700 to 1300° C. for a duration of 0.01 to 500 hours. Typically, a heat treatment at 800-1000° C. for 0.1-10 hours is used. The T_{c} is at least 35° K, advantageously at least 39° K, and the critical current density is at least 10,000 A/cm², advantageously at least 50,000 A/cm² at 4° K in a magnetic field of at least 0.1 Tesla (advantageously at a field of 1 Tesla or higher). The density of the resultant boride superconductor is typically at least 80%, advantageously at least 90% of the theoretical density.

The method is capable of providing, for example, monofilament or multifilament superconductive wire of a variety of cross sectional shapes, or to produce tape or ribbon containing one or more superconductive elements. Many systems as well as apparatus are capable of using the superconductive wire or ribbon, with the availability of the MgB₂ superconductive material making possible operation at a higher temperature than with prior art superconductive wire such as NbTi or Nb₃Sn. Such apparatus and systems include a superconductive solenoid, a particle accelerator, a maglev transportation system, a fusion reactor with magnetic confinement, and a power transmission line. It is also possible to use the bodies as signal transmission lines in electronic apparatus.

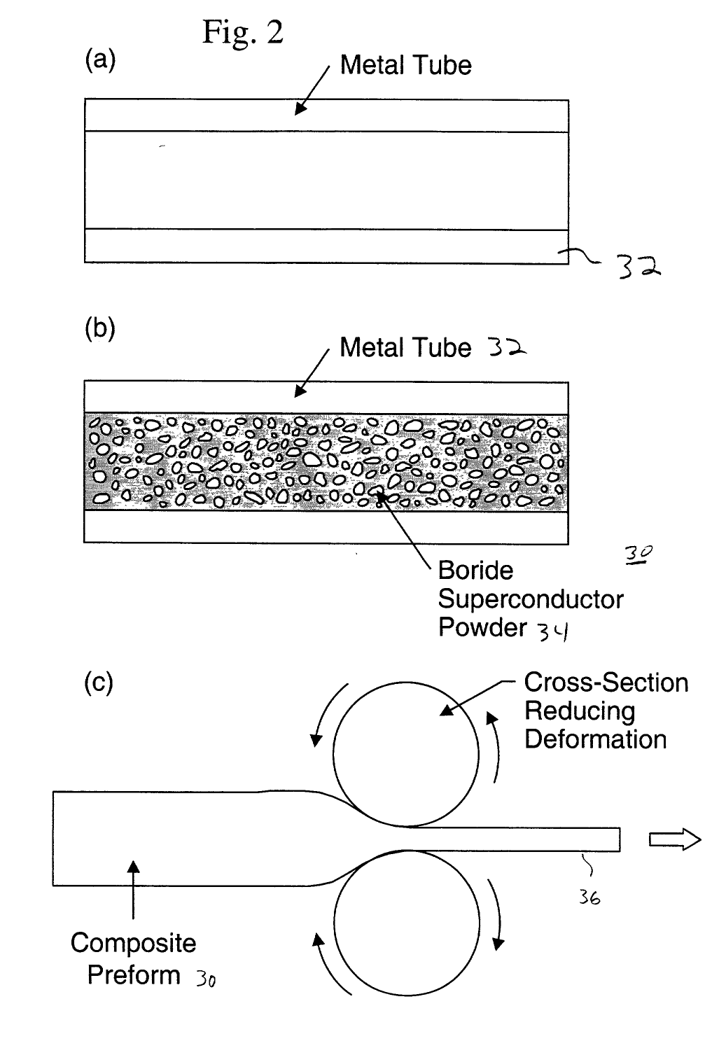

A method for forming a composite structure according to one embodiment of the invention is schematically illustrated in FIGS. 2A-2C. The method involves forming an intermediate body 30 by surrounding a quantity of the magnesium boride superconductor powder 34 with an appropriate metal cladding or jacket 32, e.g., filling the metal tube with the powder. The cross section of the intermediate body 30 is reduced, and the body length elongated, by any appropriate technique (e.g., drawing or rolling). The cross-section reduction and elongation simultaneously compacts the powder and increases the powder density. Upon heat treating of the elongate body 36, this compaction and increased density allows successful sintering in ambient or near-ambient pressure, without resorting to high pressure processing. Optionally, the elongated body is put into a desired configuration, e.g., a winding, prior to heat treatment.

In another embodiment of the invention, the metal jacket is filled with superconducting precursor material, i.e., non-superconducting constituent elements such as magnesium metal powder and boron powder, or decomposable precursors such as MgCl₂ or MgI₂ in an inert or oxygen-free atmosphere. The cross-section of the composite body is then reduced as discussed above. The resultant powder compaction and cross-section reduction provides a reduced diffusion distance for easy and convenient formation of stoichiometric superconductor compound on subsequent heat treatment. Heat treatment is then performed, such that the MgB₂ superconductor compound is created in situ and substantial sintering of the powder occurs. An advantage of this embodiment is that the problem of high vapor pressure and easy vaporization loss of Mg reduced or prevented, and ambient-pressure fabrication is possible, without the need for slow and costly heat treatment in Mg vapor environment or high pressure processing.

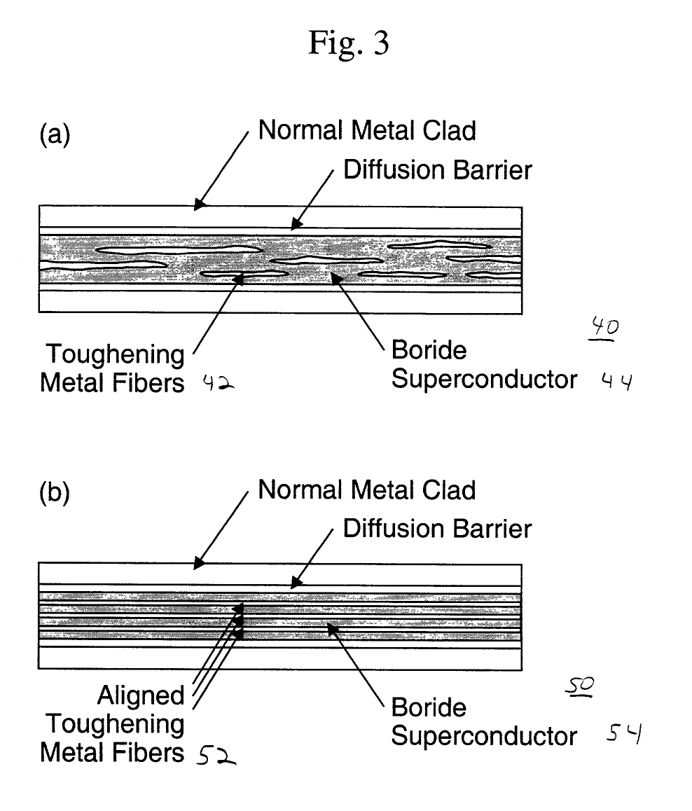

Another embodiment, illustrated in FIG. 3A, involves a superconductor body 40 which contains dispersed and elongated fibers or stringers 42 of ductile material, e.g., metal, to toughen and strengthen the relatively brittle superconductor 44. This is particularly useful in view of the presence of high Lorentz force on high-field, high-current applications of superconductor solenoid magnets. Metallic fibers or stringers which exhibit little reactions with the surrounding boride superconductor especially the Mg atoms in the superconductor are desired. Examples of such non-reactive metals include Fe, Ni, Ti, Mg, Mo, Nb, Ta, W, V, Hf. A method to fabricate such a toughened, metal-clad superconductor structure involves mixing the precursor superconductor powder or the pre-made superconductor powder with ductile yet non-reactive metal powder before feeding into the metal jacket. Upon plastic deformation and elongation, the ductile metal powder is elongated into a fiber or stringer configuration, such that the toughening/strengthening effect becomes effective for the entire length of the metal-clad superconductor wire. The volume fraction of these added stringer particles is typically in the range of 0.5-30%, more typically 1-10%. The effective diameter (i.e., diameter of a cylinder having the same cross-sectional area as the stringer) of such stringers is typically in the range of 0.05-500 micrometers, more typically 0.1-10 micrometers.

As shown in FIG. 3B, an alternative method of producing such a toughened body 50 is to embed a multitude of ductile wires 52 within the superconductor powder 54 or precursor superconductor powder, along the direction of the superconductor elongation. The diameter of such pre-aligned metal wires will be reduced together with the reduction of the cross-section of the superconductor body.

A fourth embodiment of the invention is similar to the third embodiment, but uses ductile powder or wire which is intentionally chosen to be reactive with the surrounding magnesium boride superconductor. This reactivity provides desired doping of the superconductor, for example to enhance the superconducting T_{c} of the boride superconductor or to enhance the flux-pinning characteristics for improved critical current density. Examples of such reactive materials include Li, Na, K, Rb, Cs, Ca, Sr, Ba, Cu, Ag, Au, Zn, Co, Ru, Rh, Pd, Os, Ir, and Pt.

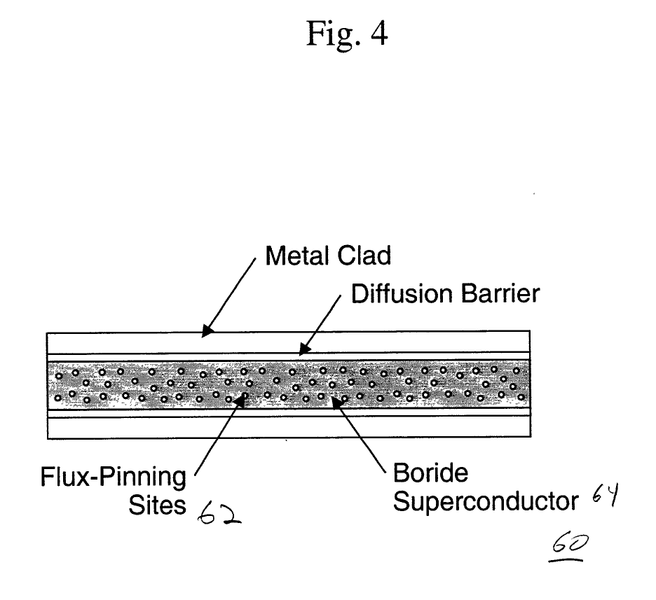

A fifth embodiment of the invention, illustrated in FIG. 4, involves a metal-clad, boride type superconductor body 60 which contains ultrafine non-superconducting flux-pinning sites 62, typically precipitates or dispersoids, distributed within the superconducting material 64. Suitable materials include oxides (e.g., commercially available 5-10 nm particles of Al₂O₃, Fe₂O₃, TiO₂, Y₂O₃, or Sm₂O₃), nitrides, carbides, borides, silicides, phosphides, chlorides, fluorides, as well as metals, alloys or intermetallic compounds, with a particle dimension on the order of the coherent length of the superconductor, e.g., with a dimension in the range of approximately 2-500 nm, typically in the range of 5-100 nm. It is possible to introduce such flux-pinning sites by mixing the fine particles into the superconductor powder or precursor superconductor powder prior to the cross-section reduction process. During the wire fabrication, these hard and brittle particles generally do not deform or elongate, and tend to maintain their size and shape (although some limited degree of pulverization and size reduction may occur). The volume percent of these added particles is in the range of 0.5-30%, typically in the range of 1-10%.

The invention is further illustrated by the following examples, which are intended to be exemplary.

### EXAMPLE 1

For MgB₂wire/ribbon fabrication, a Cu tube lined with an Fe inner tube as a diffusion barrier was used. The Cu tube had an outside diameter (OD) of 6.35 mm. The inner Fe tube had an OD of 5 mm, a wall thickness of 0.5 mm, and was 10 cm long. One end of the tube was sealed by crimping and the tube was then filled, in an argon atmosphere, with commercially available MgB₂ powder (98% purity, −325 mesh, procured from Alfa AESAR). The remaining end of the tube was also crimped by hand and the composite structure was then swaged (with wire drawn in some cases) to a 2-3 mm diameter rod followed by cold rolling to a ribbon geometry with 0.25-0.5 mm thickness, 3-5 mm width, and ˜60 cm length. The ribbon was given a sintering treatment in a laboratory furnace at 900° C./30 minutes or 1000° C./30 minutes in an argon atmosphere. A slow heating to the sintering temperature, lasting ˜3 hours, was employed. For direct and reliable measurements of T_{c} and J_{c} from the superconductor, the metal cladding was mechanically removed. The bare MgB₂ ribbon so obtained was very dense giving an audible ping when dropped onto a hard surface or cut to smaller lengths using a hand-held wire cutter.

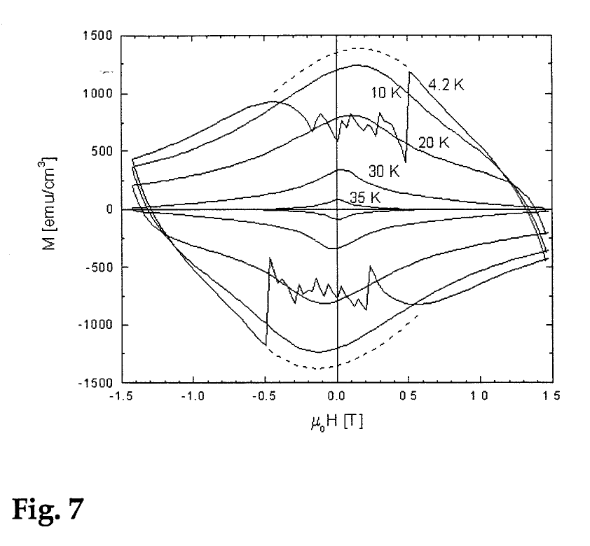

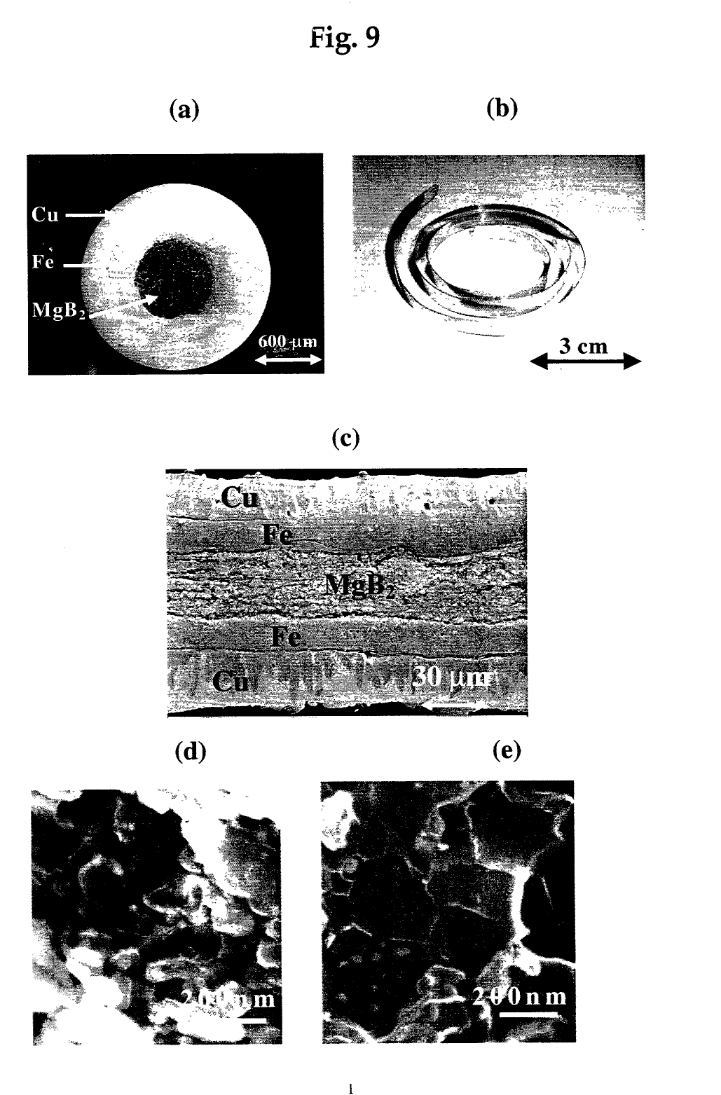

Shown in FIGS. 9A to 9E are the scanning electron microscopy (SEM) photomicrographs illustrating the structure of the heat treated (sintered) MgB₂ body. FIG. 9A is the sectional micrograph of the round preform composite, ˜2 mm in diameter, prior to cold rolling (sintered here for the purpose of metallography). FIG. 9B shows the composite Cu/Fe/MgB₂ ribbon wound into a solenoid configuration (˜6 cm diameter) prior to sintering heat treatment, and FIG. 9C is the longitudinal cross-sectional micrograph from the final ribbon. It is seen that the superconductor core deforms continuously in conformation with the composite wire geometry during the swaging/wire drawing/rolling processes, presumably by particle-particle sliding. The Cu and Fe clad metal structure is well defined and distinguishable from the MgB₂ core which is ˜35 μm thick. FIG. 9D and FIG. 9E represent the high magnification microstructure of the 900° C. and 1000° C. sintered ribbons, respectively. A dense structure with an ultrafine grain size of ˜1200 Å in average diameter was observed for the 900° C. sample. This was much finer than the size of the starting MgB₂ powder material used (our SEM analysis gave an average of ˜3 μm), indicating the occurrence of substantial grain refinement by the wire fabrication process. Such a grain refinement can allow the needed consolidation at lower temperature thus reducing the extent of undesirable metallurgical reactions, such as the contamination of MgB₂ grain boundaries. A finer grain size in a weak-link-free superconductor could also be useful for flux pinning enhancement. The 1000° C. sample, FIG. 7(e), exhibited an even denser microstructure with an average grain size of ˜2.5 times larger than that for the 900° C. sample. Unlike Y—Ba—Cu—O type superconductors, the larger grain size in MgB₂ did not lead to a significant increase in critical currents.

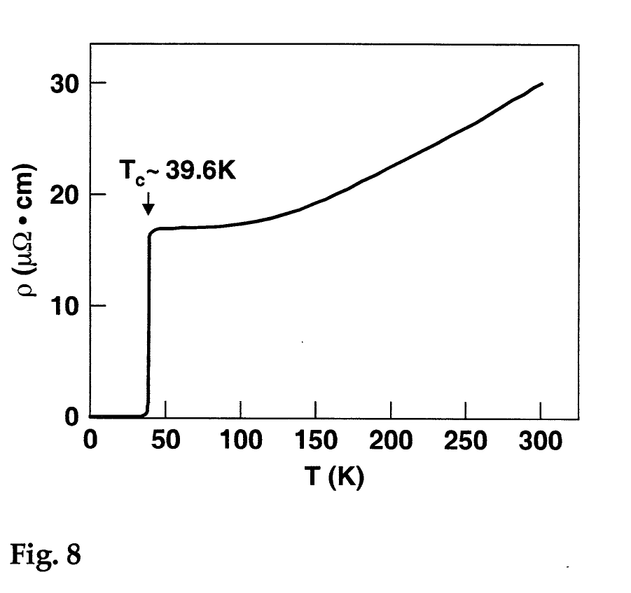

Samples of the MgB₂ wire exhibited a superconducting transition temperature equivalent to the highest value reported. Shown in FIG. 8 is the resistivity vs. temperature curve obtained by four point measurement using a 10 mA ac current. A sharp superconducting transition occurred at T_{c}(onset) ˜39.6K with the T_{c} (mid point) being ˜38.4K. The normal state resistivity, p(40K), was ˜17 μΩ-cm with the p(40K)/p(298K) ratio of ˜1/2.

### EXAMPLE 2

An iron tube with an outer diameter of ˜5 mm was filled with commercially available MgB₂ superconductor powder, and processed into metal-clad ribbon of ˜0.5 mm thickness and sintered at 900° C. for 30 minutes in Ar atmosphere according to the procedure of Example 1. This iron-clad ribbon fabrication process essentially maintained the intended stoichiometry of MgB₂. For example, the weight loss during sintering of the ribbons at 900° C., was measured to be only ˜0.8% in terms of net MgB₂ weight change. (By contrast, bare sintered pellets (prepared using a laboratory press 3000 bar compression with the MgB₂ powder under argon atmosphere before and during the pressing), after the same 900° C. sintering, lost ˜31% of weight from MgB₂ (equivalent to ˜60% loss of magnesium). The sintered pellet was so mechanically weak that electrical measurements were not possible.

The iron-clad MgB₂ ribbon samples exhibited high transport J_{c} in the regime of 10⁴˜10⁵ A/cm². In order to avoid complications due to the presence of the metal cladding, the measurement was carried out with stripped (bare) MgB₂ ribbons with approximate dimensions of 0.1-0.3 mm thick×1.2 mm wide×13 mm long. Transport critical currents were obtained from V-I characteristic curves on passing a pulse current of 30-100 amperes from a capacitor bank (˜1 ms rise time and ˜8 ms decay time) and monitoring with a transient digitizer. The current and voltage leads were attached to the sample using an In-10% Ag solder and ultrasonic soldering gun. The superconductor sample was either immersed in liquid He, or suspended above the liquid. Because of the contact resistance and the resultant heating of contacts and lead wires, only a lower limit to the critical current could be inferred. At 4.2 K, the measurement gave a lower limit J_{c}(transport)>8.5×10⁴ A/cm² for the MgB₂ ribbons. At 20 K the lower limit of J_{c}(transport) was measured to be 2.3×10⁴ A/cm².

The J_{c}(magnetization) values were also measured for the similar bare ribbon samples and compared with the J_{c}(transport). The presence of circulating supercurrents in these samples was investigated by measuring the magnetization response of the samples using a vibrating sample magnetometer (VSM). Typical M-H curves for MgB₂ (900° C. samples) are shown in FIG. 7. The data measured at 4.2 K are particularly notable; the curve shows clear and sudden magnetization changes at fields below about 0.5 Tesla. Under these conditions, the sample is evidently subject to partial flux jumps because of the large value of the critical current and small value of the heat capacity. This observation reemphasizes the need for superconductor stabilization using normal metal cladding. A crude interpolation of the data was employed to estimate J_{c}(magnetization) in the absence of the flux jumps (e.g., when they were suppressed by normal metal cladding) as indicated by the dashed line.

The M-H data can be interpreted using the well-known Bean model to yield the critical current as a function of field. Using the formula J_{c}=30ΔM/V, where J_{c} is the critical current in A/cm², ΔM is the difference between the upper and lower branches of the M-H curve, in emu/cm³, and W is the transverse width of the sample in cm, the J_{c}(magnetization) values at the temperature of 4.2K were ˜3×10⁵ A/cm² at H═0 and ˜1×10⁵ A/cm² at H=1T. At 20K, the values were ˜1.2×10⁵ A/cm² at H═0 and ˜4×10⁴ A/cm² at H=1T. The measured transport J_{c} values are essentially comparable to the zero field J_{c} (magnetization) values.

### EXAMPLE 3

To evaluate the effects of contamination of MgB₂ with other elements such as from the clad metal, the effect of several alloying metal elements on the critical current behavior of the MgB₂ material was studied. 5 mole % each of fine metal particles of Fe, Mo, Cu, Ag, Ti (˜1-10 μm average size), and Y (<˜200 μm) were thoroughly mixed (using mortar and pestle) with the MgB₂ powder, and the metal-clad ribbons fabricated as in Example 1. After sintering (900° C./30 min.) and stripping off the clad metal, the J_{c}(magnetization) properties were evaluated as a function of field and temperature.

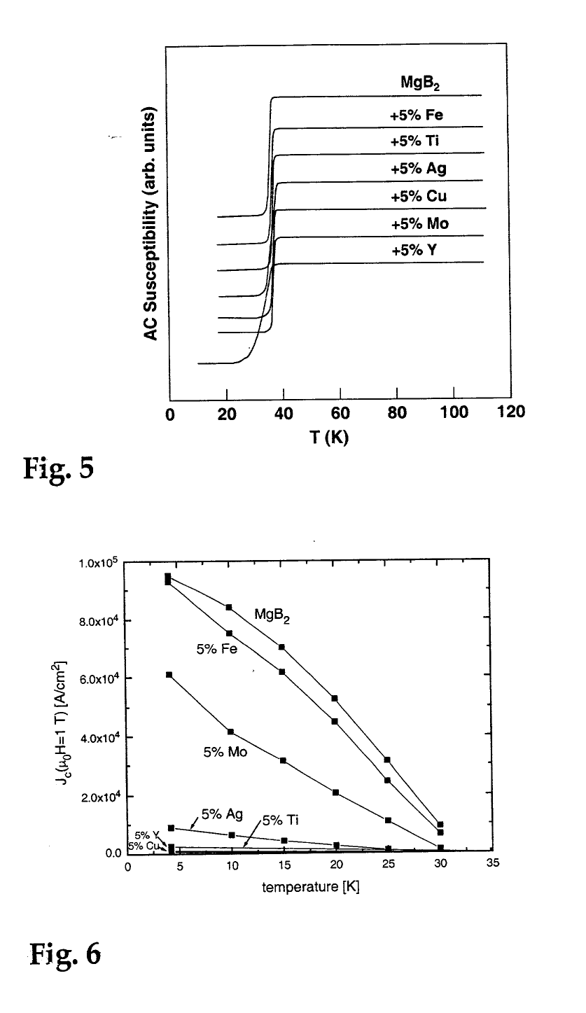

FIG. 5 shows the superconducting T_{c} of MgB₂ samples with various metal powder additions measured as a.c. susceptibility vs. temperature. The presence of these fine particles in MgB₂ during sintering at 900° C. have little effect on the T_{c} of MgB₂ (except some broadening of the susceptibility transition in the case of Y which has a considerable mutual solubility with Mg, forms a 566° C. melting point eutectic, and reacts with B). This trend was confirmed with resistivity vs. temperature measurements. This result suggests that the metal ions of Fe, Mo, Ag, Cu, Ti, and Y are not incorporated into the lattice structure of the MgB₂ superconductor phase.

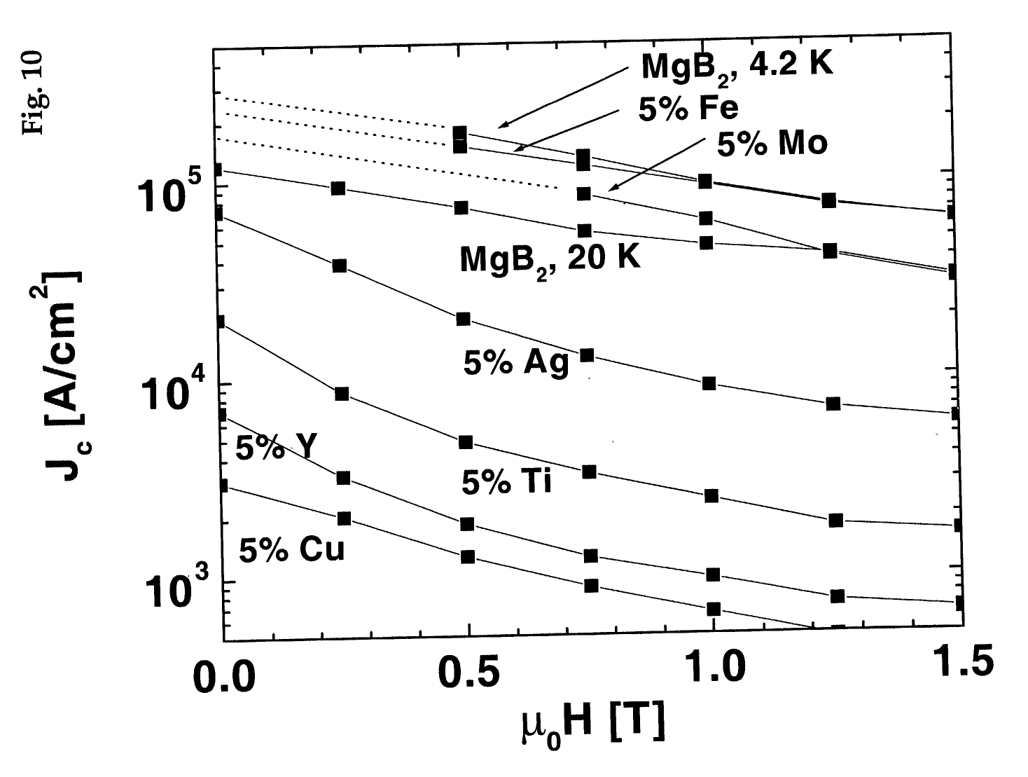

While the T_{c} of MgB₂ remains unaffected by these elements, a significant alteration of critical current behavior in these metal-containing MgB₂ samples was observed as shown in FIG. 6 (J_{c} vs. T curves) and in FIG. 10 (J_{c} vs. H curves). The Fe addition appeared to be least damaging while the Cu addition caused J_{c} to be significantly reduced by 2-3 orders of magnitude with somewhat increased field dependence of J_{c}. Upon increasing the amount of added metal particles, e.g., to 20 mole %, even more severe degradation of J_{c} properties is observed. This weak-link-like behavior observed may be caused by the diffusion of the atoms of the added metal at the sintering temperature to the MgB₂ grain boundaries (or to the MgB₂ particle surface prior to the completion of the sintering reaction). Such a reacted layer could be either non-superconducting or superconducting with reduced J_{c}, and could be continuous or semi-continuous. The presence of such grain boundary layers would strongly impede the flow of supercurrents from grain to grain. The data in FIGS. 4 and 8 demonstrate that while inherently weak-link-free, the MgB₂ superconductor can easily be altered to exhibit undesirable weak-link-like behavior with significant loss in critical current density unless the incorporation of foreign metal atoms is carefully avoided or controlled. Iron appears to be a particularly suitable material as one of the least weak-link-inducing clad metals or diffusion barrier metals for MgB₂ wire fabrication.

It is to be understood that the above-described embodiments are illustrative of only a few of the many possible specific embodiments which can represent applications of the invention.

What is claimed is:

1. A process for fabricating an article comprising a superconducting body, comprising the steps of:
providing an intermediate body comprising:
MgB₂ powder or precursor powder capable of reacting to form MgB₂;
optionally, a diffusion barrier layer around the powder, the diffusion barrier layer acting to inhibit diffusion of Mg through the layer; and
a cladding around the powder or around the powder and the diffusion barrier layer;
forming an elongate body from the intermediate body by one or more cross-section reducing operations; and
heat treating the elongate body to substantially sinter the MgB₂ powder or to react the precursor powder to form MgB₂ powder and substantially sinter the resulting MgB₂ powder.

2. The process of claim 1, wherein the diffusion barrier layer is present and comprises one or more elements selected from the group consisting of Fe, Ni, Ti, Mo, Nb, Ta, W, V, and Hf.

3. The process of claim 2, wherein the diffusion barrier layer consists of one or more metals selected from Fe, Ni, Ti, and alloys rich in Fe, Ni, or Ti.

4. The process of claim 1, wherein the intermediate body is free of the diffusion barrier layer, and wherein the cladding comprises one or more elements selected from the group consisting of Fe, Ni, Ti, Mo, Nb, Ta, W, V, and Hf.

5. The process of claim 4, wherein the cladding consists of one or more metals selected from the group consisting of Fe, Ni, Ti, or alloys rich in Fe, Ni, or Ti.

6. The process of claim 1, wherein the intermediate body further comprises non-superconductive particles or wires within the MgB₂ powder or within the precursor powder capable of reacting to form MgB₂, and wherein the particles or wires are plastically deformed during the step of forming the elongate body.

7. The process of claim 6, wherein the particle or wires are reactive with the MgB₂.

8. The process of claim 1, wherein the intermediate body further comprises non-superconductive particles within the MgB₂ powder or precursor powder capable of reacting to form MgB₂, and wherein the particles remain substantially unchanged in shape and size during the step of forming the elongate body.

9. An article comprising a superconducting body, the body comprising:
MgB₂ superconducting material;
optionally, a diffusion barrier layer around the MgB₂ material; and
a metal cladding around the MgB₂ material or around the MgB₂ material and the diffusion barrier layer.

10. The article of claim 9, wherein the diffusion barrier layer is present and comprises one or more elements selected from the group consisting of Fe, Ni, Ti, Mo, Nb, Ta, W, V, and Hf.

11. The article of claim 10, wherein the diffusion barrier layer consists of one or more metals selected from Fe, Ni, Ti, and alloys rich in Fe, Ni, or Ti.

12. The article of claim 9, wherein the body is free of the diffusion barrier layer, and wherein the cladding comprises one or more elements selected from the group consisting of Fe, Ni, Ti, Mo, Nb, Ta, W, V, and Hf.

13. The article of claim 12, wherein the cladding consists of one or more metals selected from the group consisting of Fe, Ni, Ti, or alloys rich in Fe, Ni, or Ti.

14. The article of claim 9, wherein the body further comprises non-superconductive stringers or wires within the MgB₂ material.

15. The article of claim 14, wherein the stringers or wires are reactive with MgB₂.

16. The article of claim 9, wherein the body further comprises non-superconductive particles within the MgB₂ material.

17. The article of claim 9, wherein the body is configured as a wire or a ribbon.

18. The article of claim 9, wherein the T_{c} of the MgB₂ material is at least 35K.
